(19) United States
(12) Patent Application Publication
(10) Pub. No.: US 2008/0239145 A1
(43) Pub. Date: Oct. 2, 2008

(54) IMAGE EXPANSION APPARATUS, VIDEO DISPLAY APPARATUS AND IMAGE EXPANSION METHOD

(75) Inventor: Tadayoshi Kimura, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 12/031,277

(22) Filed: Feb. 14, 2008

(30) Foreign Application Priority Data
Mar. 30, 2007 (JP) 2007-090360

(51) Int. Cl. H04N 7/01; G06K 9/32

(52) U.S. Cl. 348/448; 382/300; 348/E07.012

(57) ABSTRACT

According to one embodiment, an image expansion apparatus includes a vertical interpolating part obtaining a pixel value of an interpolation target pixel based on pixel values of an upper pixel and a lower pixel of the interpolation target pixel, a diagonal interpolating part obtaining a pixel value of the interpolation target pixel based on pixel values of a pixel at a diagonally upper side and a pixel at a diagonally lower side of the interpolation target pixel, which are two pixels in opposite directions with the interpolation target pixel as a center, a difference computing part obtaining a difference between a pixel value of an image block including the interpolation target pixel and a mean value of pixel values of two image blocks at both left and right sides of the image block, as an index value expressing an edge shape in a periphery of the interpolation target pixel, and a mixing part mixing the pixel value of the interpolation target pixel obtained by the vertical interpolating part and the pixel value of the interpolation target pixel obtained by the diagonal interpolating part in accordance with a mixture ratio corresponding to the index value of the edge shape obtained by the difference computing part.

### CROSS-REFERENCE TO RELATED APPLICATIONS

This application is based upon and claims the benefit of priority from Japanese Patent Application No. 2007-90360, filed Mar. 30, 2007, the entire contents of which are incorporated herein by reference.

### BACKGROUND

1. Field

One embodiment of the invention relates to an image expansion apparatus which expands an image by interpolating a pixel value, a video display apparatus constituted by including the image expansion apparatus, an image expansion method for expanding an image by interpolating a pixel value.

2. Description of the Related Art

In a digital television apparatus, for example, an image expansion apparatus which enlarges a digital image is used. In such an image expansion apparatus, a digital image is enlarged by generating a new pixel line between already-existing image lines. When generating the new image line, the image expansion apparatus interpolates a pixel value of a pixel which it newly generates by using pixel values of the already-existing pixels.

An example of the image expanding apparatus is disclosed in the prior document (Japanese Patent Application Laid-open No. 2006-222965). In the image expansion apparatus according to the prior document, an edge direction in an image is detected, and a pixel value is interpolated in the detected edge direction. However, in the image expansion apparatus according to the prior document, error interpolation of a pixel value is not taken into consideration.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing an image expansion apparatus according to an embodiment of the invention;

FIG. 2 is an exemplary block diagram showing a vertical double scaling part in detail in the embodiment;

FIG. 3 is an exemplary schematic view showing an input image which is inputted into the image expansion apparatus in the embodiment;

FIG. 4 is an exemplary schematic view showing a converted input image in the embodiment;

FIG. 5 is an exemplary schematic view for explaining vertical interpolation in the embodiment;

FIG. 6 is an exemplary schematic view showing an ideal interpolation state in the embodiment;

FIG. 7 is an exemplary schematic view showing an interpolation state by vertical interpolation in the embodiment;

FIG. 8 is a first schematic view for explaining diagonal interpolation in the embodiment;

FIG. 9 is an exemplary second schematic view for explaining the diagonal interpolation in the embodiment;

FIG. 10 is an exemplary third schematic view for explaining the diagonal interpolation in the embodiment;

FIG. 11 is an exemplary fourth schematic view for explaining the diagonal interpolation in the embodiment;

FIG. 12 is an exemplary fifth schematic view for explaining the diagonal interpolation in the embodiment;

FIG. 13 is an exemplary sixth schematic view for explaining the diagonal interpolation in the embodiment;

FIG. 14 is an exemplary seventh schematic view for explaining the diagonal interpolation in the embodiment;

FIG. 15 is an exemplary eighth schematic view for explaining the diagonal interpolation in the embodiment;

FIG. 16 is an exemplary first schematic view for explaining mixing processing in the embodiment;

FIG. 17 is an exemplary second schematic view for explaining the mixing processing in the embodiment;

FIGS. 18A to 18D are exemplary third schematic views for explaining the mixing processing in the embodiment;

FIG. 19 is an exemplary fourth schematic view for explaining the mixing processing in the embodiment;

FIG. 20 is an exemplary fifth schematic view for explaining the mixing processing in the embodiment;

FIG. 21 is an exemplary flowchart showing processing by the image expansion apparatus in the embodiment;

FIG. 22 is an exemplary schematic view showing a modified example of the embodiment; and

FIG. 23 is an exemplary block diagram showing one example of a television apparatus including the image expansion apparatus in the embodiment.

### DETAILED DESCRIPTION

Various embodiments according to the invention will be described hereinafter with reference to the accompanying drawings. In general, according to one embodiment of the invention, an image expansion apparatus includes a vertical interpolating part obtaining a pixel value of an interpolation target pixel based on pixel values of an upper pixel and a lower pixel of the interpolation target pixel, a diagonal interpolating part obtaining a pixel value of the interpolation target pixel based on pixel values of an pixel at a diagonally upper side and a pixel at a diagonally lower side of the interpolation target pixel, which are two pixels in opposite directions with the interpolation target pixel as a center, a difference computing part obtaining a difference between a pixel value of an image block including the interpolation target pixel and a mean value of pixel values of two image blocks at both left and right sides of the image block, as an index value expressing an edge shape in a periphery of the interpolation target pixel, and a mixing part mixing the pixel value of the interpolation target pixel obtained by the vertical interpolating part and the pixel value of the interpolation target pixel obtained by the diagonal interpolating part in accordance with a mixture ratio corresponding to the index value of the edge shape obtained by the difference computing part.

Further, a video display apparatus includes a vertical interpolating part obtaining a pixel value of an interpolation target pixel based on pixel values of an upper pixel and a lower pixel of the interpolation target pixel, a diagonal interpolating part obtaining a pixel value of the interpolation target pixel based on pixel values of a pixel at a diagonally upper side and a pixel at a diagonally lower side of the interpolation target pixel, which are two pixels in opposite directions with the interpolation target pixel as a center, a difference computing part obtaining a difference between a pixel value of an image block including the interpolation target pixel and a mean value of pixel values of two image blocks at both left and right sides of the image block as an index value expressing an edge shape in a periphery of the interpolation target pixel, a mixing part mixing the pixel value of the interpolation target pixel obtained by the vertical interpolating part and the pixel value of the interpolation target pixel obtained by the diagonal interpolating part, and a display displaying an image mixed by the mixing part.

Further, an image expansion method is an image expansion method includes obtaining a difference between a pixel value of an image block including an interpolation target pixel and a mean value of pixel values of two image blocks at both left and right sides of the image block as an index value expressing an edge shape in a periphery of the interpolation target pixel, and mixing a pixel value of the interpolation target pixel obtained by vertical interpolation and a pixel value of the interpolation target pixel obtained by diagonal interpolation in accordance with a mixture ratio corresponding to the index value of the edge shape.

(Configuration of Image Expansion Apparatus)

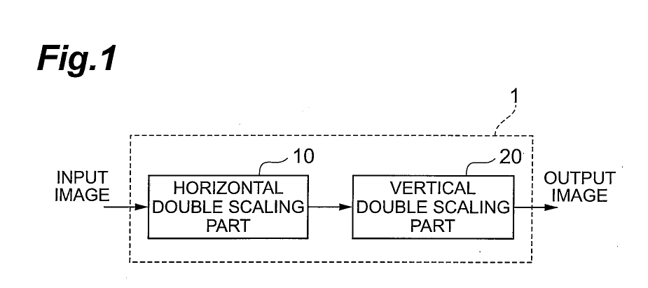

FIG. 1 is an exemplary block diagram of an image expansion apparatus 1 according to the embodiment. The image expansion apparatus 1 takes in an input image, expands the input image in a horizontal direction and a vertical direction, and thereafter, outputs the expanded image as an output image. The image expansion apparatus 1 includes a horizontal double scaling part 10 which expands the input image to be doubled in the horizontal direction, and a vertical double scaling part 20 which expands the input image to be doubled in the vertical direction.

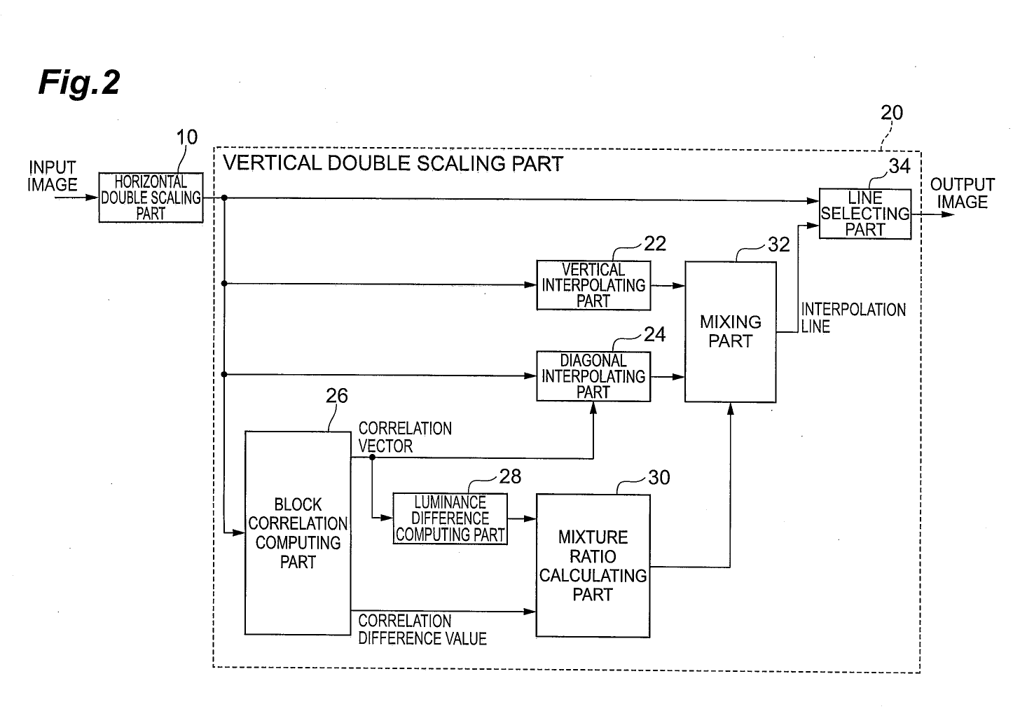

FIG. 2 is a block diagram showing the vertical double scaling part 20 in detail. The vertical double scaling part 20 includes a vertical interpolating part 22, a diagonal interpolating part 24, a line selecting part 34, a block correlation computing part 26, a luminance difference computing part 28, a mixture ratio calculating part 30 and a mixing part 32.

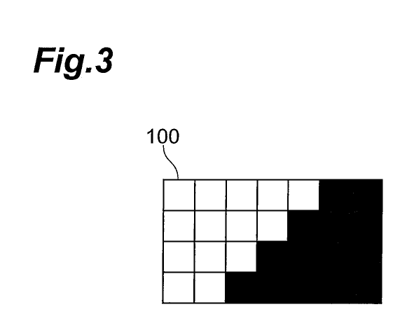

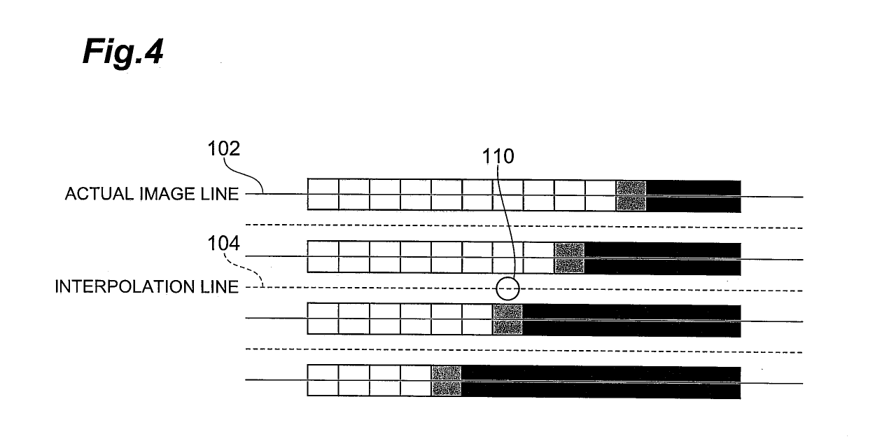

For example, when an input image 100 shown in FIG. 3 is inputted in the image expansion apparatus 1, the horizontal double scaling part 10 generates new vertical pixel lines between already-existing vertical pixel lines. The input image which is converted by the horizontal double scaling part 10 is shown in FIG. 4. Next, the vertical double scaling part 20 generates a new horizontal pixel line (interpolation line) 104 shown by a broken line between already-existing horizontal pixel lines (actual image lines) 102 shown by solid lines.

In this embodiment, the vertical double scaling part 20 uses the interpolation in the vertical direction by which the pixel value of the interpolation target pixel 110 is interpolated based on the pixel value (luminance value) of at least one pixel existing in the vertical direction of the interpolation target pixel 110, and the interpolation in the diagonal direction by which the pixel value of the interpolation target pixel 110 is interpolated based on the pixel value of at least one pixel existing in the diagonal direction of the interpolation target pixel 110 in combination. In this embodiment, the pixel value of each of the pixels is a luminance value, but the pixel value of each of the pixels may be a color value.

(Vertical Interpolation Processing)

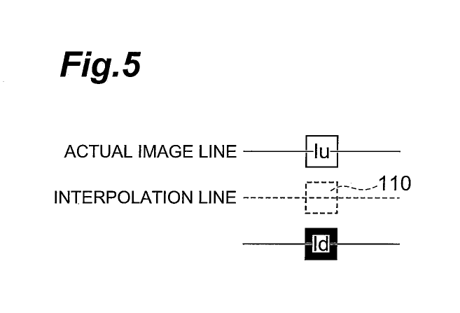

With reference to FIGS. 5 to 7, vertical interpolation processing executed by the vertical double scaling part 20 will be described. The vertical interpolation processing is executed by the vertical interpolating part 22 of the vertical double scaling part 20.

As shown in FIG. 5, in the vertical interpolation processing, the luminance value of the interpolation target pixel 110 is interpolated by using a luminance value Iu of the pixel at an upper side of it and a luminance value Id of the pixel at a lower side of it. More specifically, the luminance value of the interpolation target pixel 110 is obtained by an interpolation method such as linear interpolation and a cubic convolution interpolation, based on the luminance value Iu of the pixel at the upper side of it and the luminance value Id of the pixel at the lower side of it.

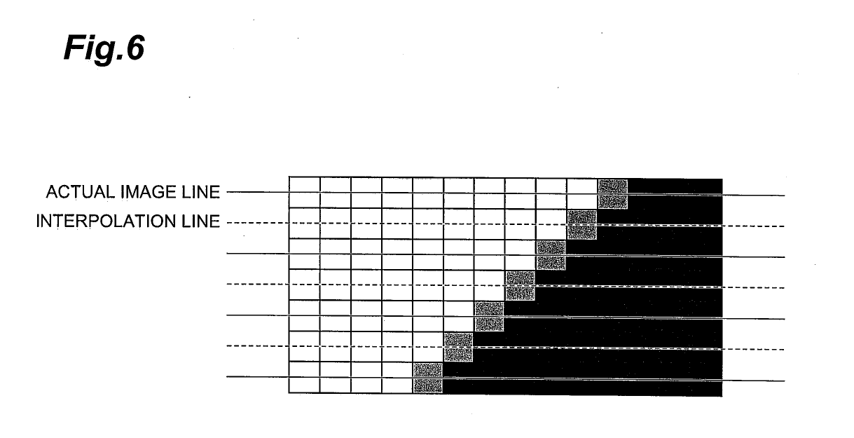

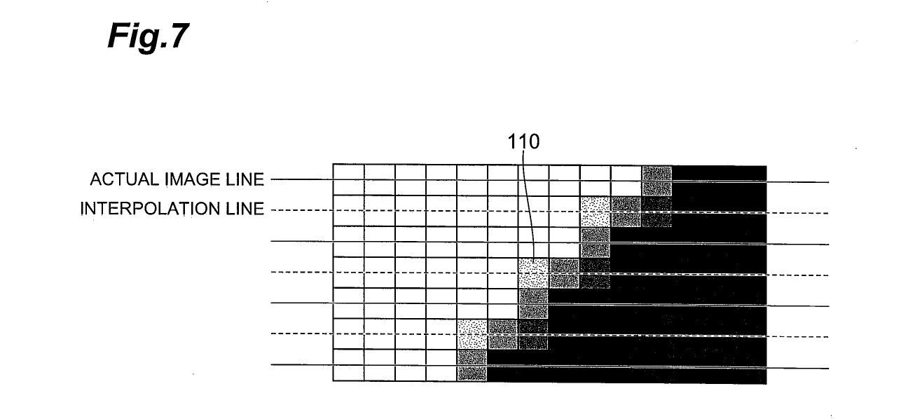

The input image shown in FIG. 4 is ideally interpolated as shown in FIG. 6, and an edge between a high luminance area and a low luminance area preferably becomes clear. However, when only the above described vertical interpolation is performed, the luminance value of the interpolation target pixel 110 becomes an intermediate luminance value as shown in FIG. 7, and an edge between the high luminance area and the low luminance area has a jagged image. Incidentally, the jagged edge is called jaggy. In order to perform interpolation more ideally by suppressing such jaggy, the vertical interpolation and diagonal interpolation are used in combination in this embodiment.

(Diagonal Interpolation Processing)

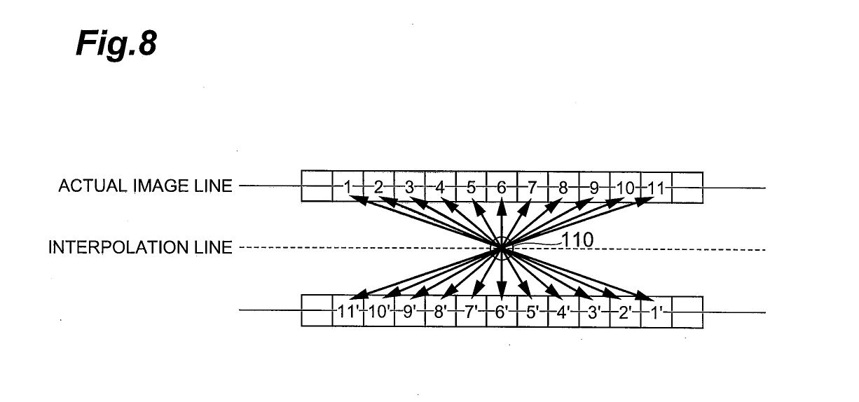

With reference to FIGS. 8 to 15, the diagonal interpolation processing executed by the vertical double scaling part 20 will be described. The diagonal interpolation processing is executed by the diagonal interpolating part 24 and the block correlation computing part 26 of the vertical double scaling part 20.

In the diagonal interpolation processing, the luminance value of the interpolation target pixel 110 is interpolated by using the luminance values of a plurality of pixels 1 to 11 arranged at an upper side of the interpolation target pixel 110, and the luminance values of a plurality of pixels 1′ to 11′ arranged at a lower side of the interpolation target pixel 110, as shown in FIG. 8.

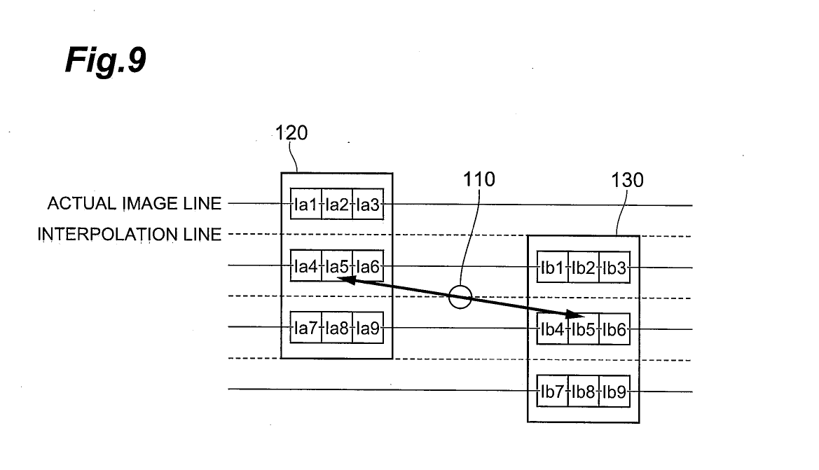

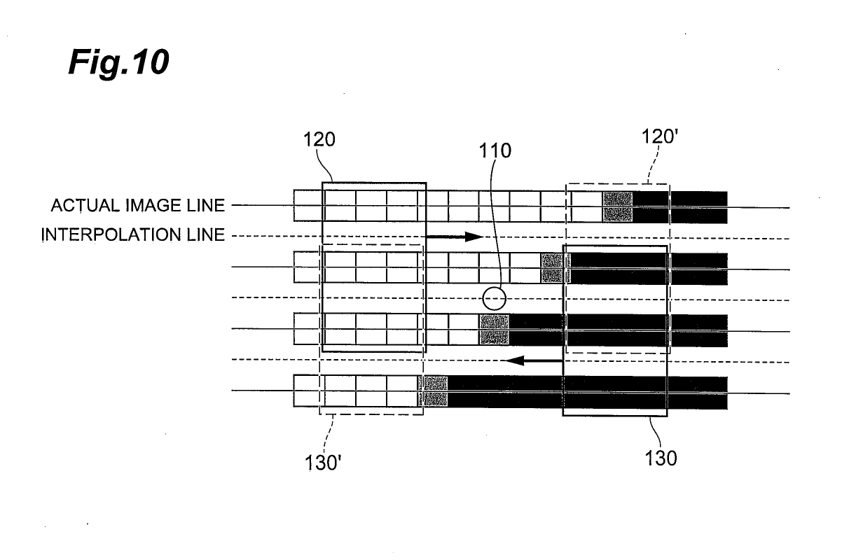

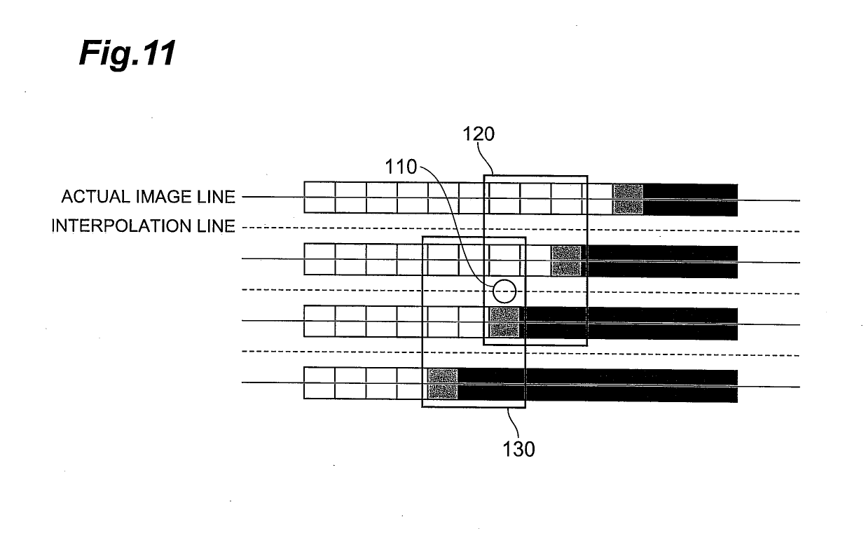

The block correlation calculating part 26 searches two image blocks of which correlation is maximum. Specifically, as shown in FIG. 9, the block correlation calculating part 26 sets an image block A120 at a diagonally upper left side seen from the interpolation target pixel 110, and an image block B130 at a diagonally lower right side seen from the interpolation target pixel 110. Subsequently, as shown in FIG. 10, the block correlation computing part 26 shifts the image block A120 in the horizontal direction up to the position of an image block A120′ shown by a broken line, and shifts the image block B130 in the horizontal direction up to the position of an image block B130′ shown by a broken line. When the image block A120 and the image block B130 are shifted, the image block A120 and the image block B130 are in the opposite directions from each other with the interpolation target pixel 110 as a reference, and keep the relation at an equal distance from the interpolation target pixel 110. The block correlation computing part 26 calculates correlation of the image block A120 and the image block B130 in each of the positions to which they are shifted, and searches the position in which the correlation of the image block A120 and the image block B130 becomes maximum. As a result, as shown in FIG. 11, the block correlation computing part 26 determines the position in which the correlation of the image block A120 and the image block B130 becomes maximum. The block correlation computing part 26 outputs the information of the determined directions of the image block A120 and the image block B130 as correlation vectors.

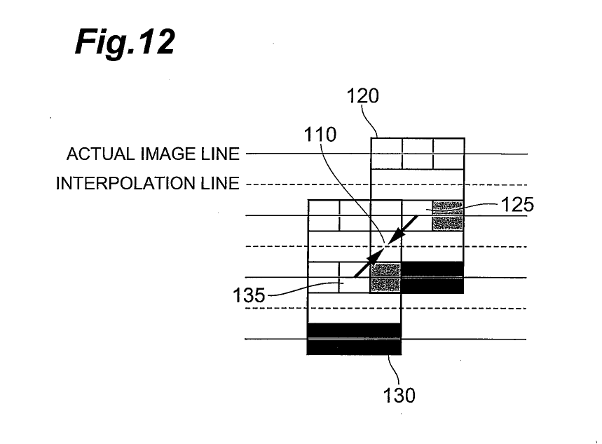

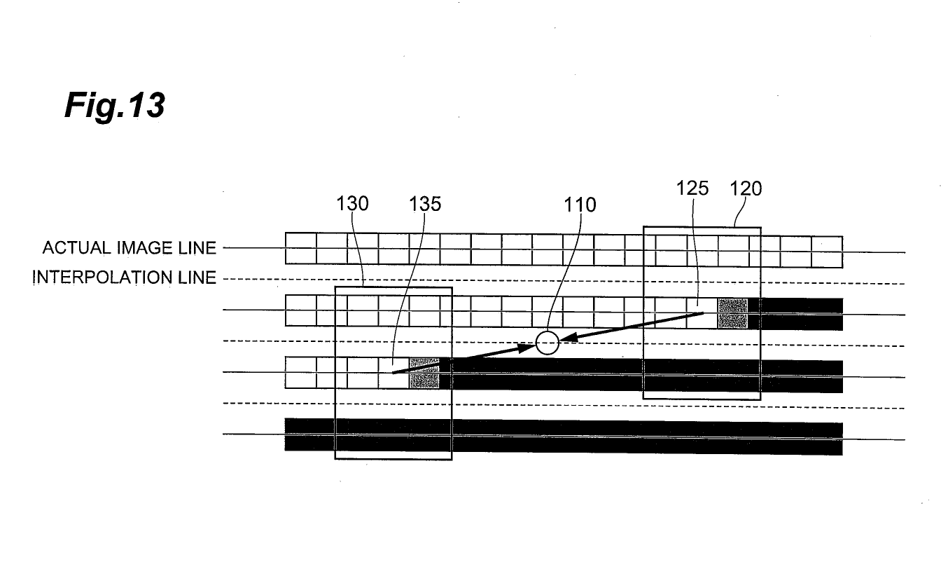

The diagonal interpolating part 24 specifies the positions of the image block A120 and the image block B130 by using the correlation vectors computed by the block correlation computing part 26. Subsequently, the diagonal interpolating part 24 interpolates the luminance value of the interpolation target pixel 110 by using the pixel values of the image block A120 and the image block B130 having the maximum correlation. More specifically, as shown in FIG. 12, the diagonal interpolating part 24 calculates the mean value of the luminance value of a pixel 125 in the center of the image block A120 and the luminance value of a pixel 135 in the center of the image block A130 as the luminance value of the interpolation target pixel 110. In FIG. 12, an example in which the inclined angle of the edge is large is shown, but when the inclined angle of the edge is small as shown in FIG. 13, the luminance value of the interpolation target pixel 110 is similarly interpolated.

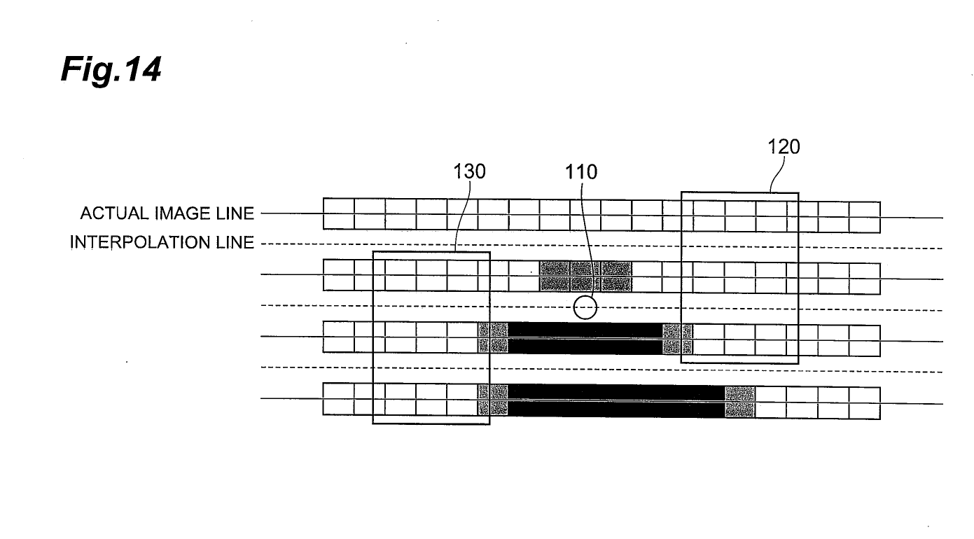

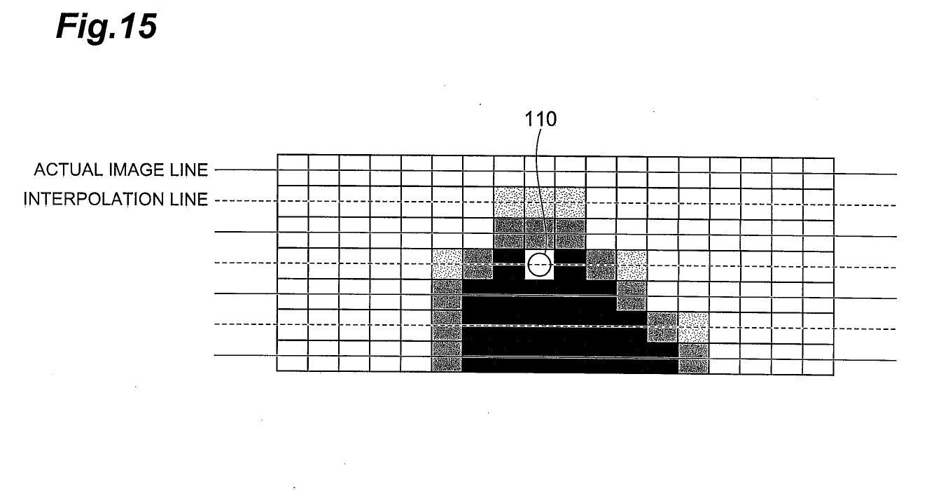

In the diagonal interpolation processing described above, the inclined angle of the edge is constant, but when the edge is bent, the diagonal interpolation processing is not sometimes performed properly. For example, when the edge is in the shape projected from a lower portion as shown in FIG. 14, the two high luminance areas 120 and 130 separated from the border are determined as the positions having the maximum correlation, and the luminance value of the interpolation target pixel 110 is interpolated. As a result, as shown in FIG. 15, error interpolation in which the high luminance pixel 110 comes out in a dot shape in the low luminance area occurs. The image expansion apparatus 1 of this embodiment copes with such error interpolation.

(Mixing Processing of Vertical Interpolation and Diagonal Interpolation)

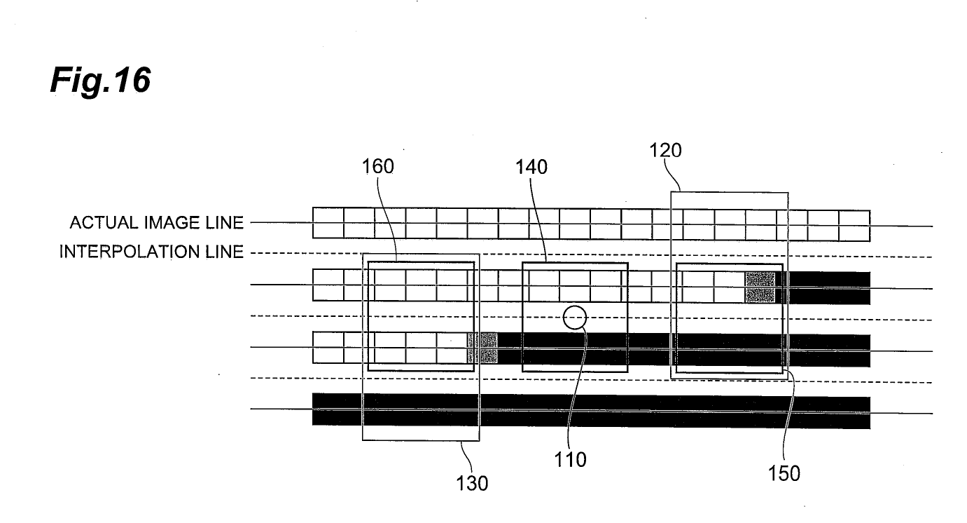

With reference to FIGS. 16 to 20, mixing processing of the vertical interpolation and the diagonal interpolation executed by the vertical double scaling part 20 will be described. The mixing processing of the vertical interpolation and the diagonal interpolation is executed by the block correlation computing part 26 of the vertical double scaling part 20, the luminance difference computing part 28, the mixture ratio calculating part 30 and the mixing part 32.

The mixing processing of the vertical interpolation and the diagonal interpolation will be described with a situation shown in FIG. 16 as an example. In FIG. 16, a linear edge extends in a diagonal direction, and the image block A120 and the image block B130 of which correlation is maximum are set. Further, an image block C140 with the interpolation target pixel 110 as a center, an image block D150 at a right side of the image block C140, and an image block E160 at a left side of the image block C140 are set. The image block D150 is inside the image block A120, whereas the image block E160 is inside the image block B130.

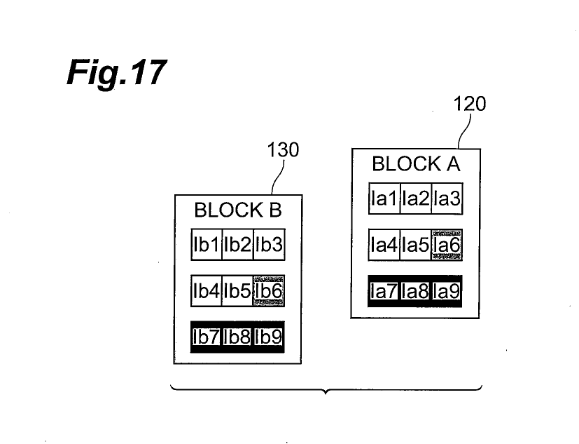

The block correlation computing part 26 calculates a difference of the luminance values of two pixels in corresponding relation in the image block A120 and the image block B130 for each of all the pixels in the image block A120 and the image block B130, and adds absolute values of the calculated all the differences. The value thus calculated is an index value of the correlation of the image block A and the image block B, and the index value will be called a correlation difference value D1 of the image block A and the image block B in the following description. The correlation difference value D1 is the numerical value which becomes smaller as the correlation of the image block A and the image block B is higher, and becomes larger as the correlation of the image block A and the image block B is lower. More specifically, when the luminance values of the respective pixels of the image block A are set as Ia1 to Ia9, and the luminance values of the respective pixels of the image block B are set as Ib1 to Ib9 as shown in FIG. 17, the block correlation computing part 26 calculates the correlation difference value D1 in accordance with the following formula (1).

D1=abs(Ia1−Ib1)+abs(Ia2−Ib2)+abs(Ia3−Ib3)+abs(Ia4−Ib4)+abs(Ia5−Ib5)+abs(Ia6−Ib6)+abs(Ia7−Ib7)+abs(Ia8−Ib8)+abs(Ia9−Ib9) (1)

The luminance difference computing part 28 sets the image block C140 with the interpolation target pixel 110 as the center. The luminance difference computing part 28 uses the correlation vectors computed by the block correlation computing part 26, and sets the image block D150 and the image block E160 in the horizontal direction of the image block C140. Specifically, the luminance difference computing part 28 sets the image block D150 at a position in the horizontal direction on the right of the image block C140 inside the image block A120 specified by the correlation vector. Further, the luminance difference computing part 28 sets the image block E160 at a position in the horizontal direction on the left of the image block C140 inside the image block B130 specified by the correlation vector. The image block D150 and the image block E160 are at the positions equidistant from the image block C140.

The luminance difference computing part 28 calculates a luminance value S1 of the image block C140, and a mean value S2 of the luminance values of the image block D150 and the image block E160, and calculates a difference S2−S1 of the luminance values. Describing in more detail, the luminance difference computing part 28 calculates a total sum of the luminance values of all the pixels included in the image block C as the value expressing the luminance value S1 of the image block C140. The luminance difference computing part 28 adds the luminance values of all the pixels included in the image block D and the image block E and obtains a total sum of these luminance values, and thereafter, calculates a half of the total sum of the luminance values, as the value expressing the mean value S2 of the luminance values of the image block D150 and the image block E16. Subsequently, the luminance difference computing part 28 calculates an absolute value D2 of a difference of the total sum S1 of the luminance values of the image block C140 and a half of the total sum S2 of the luminance values of the image block D150 and the image block E160.

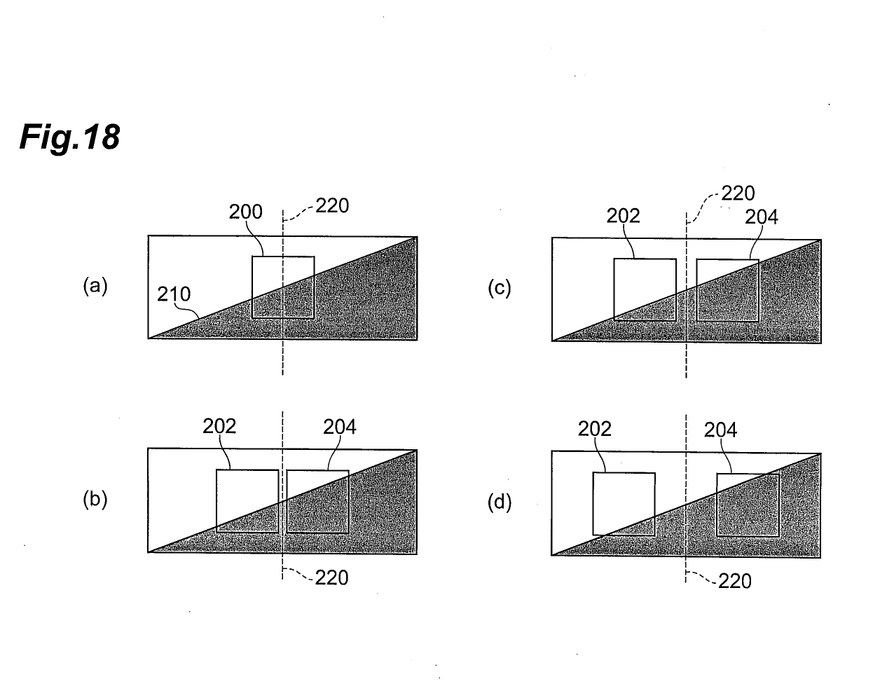

The value D2 calculated by the luminance difference computing part 28 is an index value which expresses an edge shape of the periphery of the interpolation target pixel. The value D2 calculated by the luminance difference computing part 28 uses the characteristic of the image in which the linear edge diagonally extends as shown in FIGS. 18A to 18D. An image block 200 in which the edge passes through its center as shown in FIG. 18A, and two image blocks 202 and 204 which are laterally symmetrical with a center line 220 as a reference as shown in FIG. 18B are assumed. In this case, there is the characteristic that the mean value of the luminance values of the image block 200 of FIG. 18A and the mean value of the luminance values of the two image blocks 202 and 204 of FIG. 18B become substantially equal. Such a characteristic does not change even when the separation distance of the two image blocks 202 and 204 becomes large as shown in FIGS. 18C and 18D.

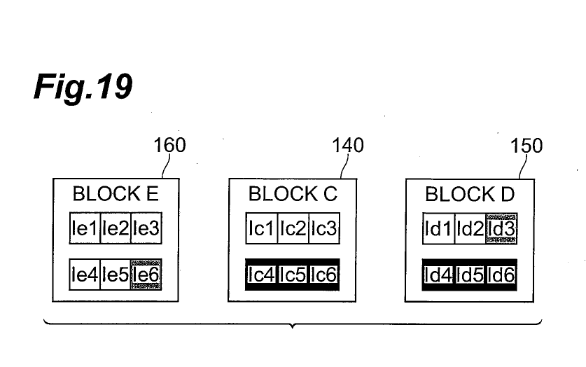

Specifically, as the edge in the periphery of the interpolation target pixel is straighter, the value D2 calculated by the luminance difference computing part 28 becomes smaller, and as the edge in the periphery of the interpolation target pixel is more bent, the value D2 calculated by the luminance difference computing part 28 becomes larger. More specifically, when the luminance values of the respective pixels of the image block C140 are set as Ic1 to Ic6, the luminance values of the respective pixels of the image block D150 are set as Id1 to Id6, and the luminance values of the respective pixels of the image block E160 are set as Ie1 to Ie6 as shown in FIG. 19, the luminance difference computing part 28 calculates an index value D2 in accordance with the following formula (2).

$$D 2 = abs ( \frac{\begin{matrix}\begin{matrix}( ( Id 1 + Id 2 + Id 3 + Id 4 + Id 5 + Id 6 + \\ ( Ie 1 + Ie 2 + Ie 3 + Ie 4 + Ie 5 + Ie 6 ) ) -\end{matrix} \\ ( Ic 1 + Ic 2 + Ic 3 + Ic 4 + Ic 5 + Ic 6 )\end{matrix}}{2} ) \qquad ( 2 )$$

Further, the luminance difference computing part 28 calculates an absolute value D3 of a difference of the luminance value of a pixel at an upper side of the interpolation target pixel 110 and the luminance value of a pixel at a lower side of the interpolation target pixel 110. The value D3 calculated by the luminance difference computing part 28 is an index value expressing a pixel value change in the vertical direction in the interpolation target pixel. As the change in the luminance value in the vicinity of the interpolation target pixel 110 is larger, the value D3 calculated by the luminance difference computing part 28 becomes larger, whereas the change in the luminance value in the vicinity of the interpolation target pixel 110 is smaller, the value D3 calculated by the luminance difference computing part 28 becomes smaller. More specifically, when the luminance value of the pixel at the upper side of the interpolation target pixel 110 is set as Iu, and the luminance value of the pixel at the lower side of the interpolation target pixel 110 is set as Id as shown in FIG. 5, the luminance difference computing part 28 calculates the index value D3 in accordance with the following formula (3).

D3=abs(Iu−Id) (3)

The mixture ratio calculating part 30 calculates a parameter k which determines the mixture ratio of the vertical interpolation and the diagonal interpolation. More specifically, the mixture ratio calculating part 30 calculates the parameter k in accordance with the following formula (4). The following formula (4) is an empirical formula by which it is verified that the luminance value is favorably interpolated.

$$k = \frac{( D 1 + 4 * D 2 ) * 2}{D 3} \qquad ( 4 )$$

The mixing part 32 mixes the luminance value Iv of the interpolation target pixel 110 calculated by the vertical interpolating part 22 and the luminance value Is of the interpolation target pixel 110 calculated by the diagonal interpolating part 24, and performs the processing of calculating the luminance value of the interpolation target pixel 110. More specifically, the mixing part 32 calculates the luminance value I of the interpolation target pixel 110 in accordance with the following formula (5).

I=k*Iv+(16−k)*Is (5)

From the above described formula (4) and formula (5), it can be understood that the luminance value I of the interpolation target pixel 110 has a tendency which will be described as follows. As the index value D1 of the correlation of the image block A and the image block B is larger, the ratio of the vertical interpolation is larger and the ratio of the diagonal interpolation is smaller in the luminance value I of the interpolation target pixel 110. As the index value D2 expressing the edge shape in the periphery of the interpolation target pixel 110 is larger, the ratio of the vertical interpolation is larger and the ratio of the diagonal interpolation is smaller in the luminance value I of the interpolation target pixel 110. As the index value D3 expressing the change in the pixel value in the vertical direction in the interpolation target pixel 110 is larger, the ratio of the vertical interpolation is smaller and the ratio of the diagonal interpolation is larger in the luminance value I of the interpolation target pixel 110.

The line selecting part 34 selects either one of the horizontal pixel line from the horizontal double scaling part 10 or the horizontal pixel line from the mixing part 32, and outputs it.

(Effect of the Embodiment)

In the image expansion apparatus 1 of this embodiment, as the index value D2 expressing the edge shape in the periphery of the interpolation target pixel 110 is smaller, the ratio of the luminance value Iv obtained by the vertical interpolation is made smaller, and the ratio of the luminance value Is obtained by the diagonal interpolation is made larger. As the index value D2 expressing the edge shape in the periphery of the interpolation target pixel 110 is larger, the ratio of the luminance value Iv obtained by the vertical interpolation is made larger, and the ratio of the luminance value Is obtained by the diagonal interpolation is made smaller.

Accordingly, when the edge extends linearly in the periphery of the interpolation target pixel 110 as shown in FIG. 16, the index value D2 expressing the edge shape in the periphery of the interpolation target pixel 110 becomes small, and the ratio of the luminance value Iv obtained from the vertical interpolation is made small, whereas the ratio of the luminance value Is obtained by the diagonal interpolation is made large. Thereby, the interpolation target pixel 110 is favorably interpolated while suppressing jaggy by the diagonal interpolation.

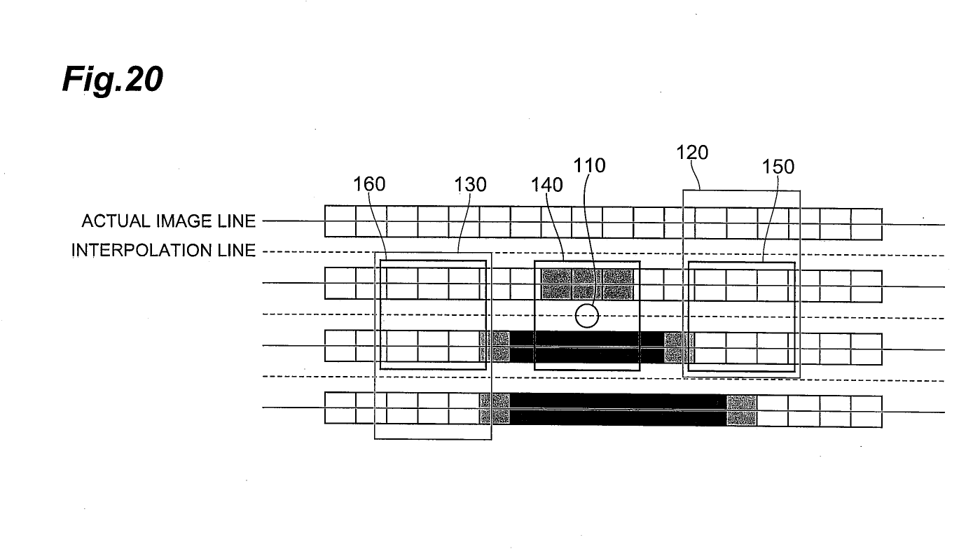

When the edge is bent in the periphery of the interpolation target pixel 110 as shown in FIG. 20, the index value D2 expressing the edge shape in the periphery of the interpolation target pixel 110 becomes large, and the ratio of the luminance value Iv obtained by the vertical interpolation is made large, whereas the ratio of the luminance value Is obtained by the diagonal interpolation is made small. Therefore, the interpolation target pixel 110 is favorably interpolated while suppressing error interpolation in a dot shape by the vertical interpolation.

Further, in the image expansion apparatus 1 of the embodiment, the ratio of the luminance value Iv obtained by the vertical interpolation is set to be smaller and the ratio of the luminance value Is obtained by the diagonal interpolation is set to be larger, as the index value D1 of the correlation of the image block A and the image block B is smaller. As the index value D1 of the correlation of the image block A and the image block B is larger, the ratio of the luminance value Iv obtained by the vertical interpolation is made larger, and the ratio of the luminance value Is obtained by the diagonal interpolation is made smaller.

Accordingly, when the edge linearly extends in the periphery of the interpolation target pixel 110, and the image block A and the image block B are favorably correlated, the index value D1 of the correlation of the image block A and the image block B becomes small, and the ratio of the luminance value Iv obtained by the vertical interpolation is made small, whereas the ratio of the luminance value Is obtained by the diagonal interpolation is made large. Therefore, the interpolation target pixel 110 is favorably interpolated while suppressing jaggy by the diagonal interpolation.

When the image block A and the image block B are not favorably correlated, the index value D1 of the correlation of the image block A and the image block B becomes large, and the ratio of the luminance value Iv obtained by the vertical interpolation is made large, whereas the ratio of the luminance value Is obtained by the diagonal interpolation is made small. Therefore, error interpolation which is caused by performing diagonal interpolation under the situation in which the image block A and the image block B are not correlated is suppressed.

In the image expansion apparatus 1 of this embodiment, the ratio of the luminance value Iv obtained by the vertical interpolation is made smaller and the ratio of the luminance value Is obtained by the diagonal interpolation is made larger as the index value D3 expressing the luminance value change in the vertical direction in the interpolation target pixel 110 is larger. As the index value D3 which expresses the luminance value change in the vertical direction in the interpolation target pixel 110 is smaller, the ratio of the luminance value Iv obtained by the vertical interpolation is made larger, whereas the ratio of the luminance value Is obtained by the diagonal interpolation is made smaller.

Accordingly, when the difference between the luminance value of the pixel at the upper side of the interpolation target pixel 110 and the luminance value of the pixel at the lower side of the interpolation target pixel 110 is large, the index value D3 which expresses the luminance value change in the vertical direction in the interpolation target pixel 110 becomes large, and the ratio of the luminance value Iv obtained by the vertical interpolation is made small, and the ratio of the luminance value Is obtained by the diagonal interpolation is made large. Thereby, the interpolation target pixel 110 is favorably interpolated while suppressing jaggy by the diagonal interpolation.

When the difference between the luminance value of the pixel at the upper side of the interpolation target pixel 110 and the luminance value of the pixel at the lower side is small on the other hand, the index value D3 which expresses the luminance value change in the vertical direction in the interpolation target pixel 110 becomes small, and the ratio of the luminance value Iv obtained by the vertical interpolation is made large, whereas the ratio of the luminance value Is obtained by the diagonal interpolation is made small. Thereby, the interpolation target pixel 110 is favorably interpolated by the vertical interpolation.

(Flow of Image Expansion Processing)

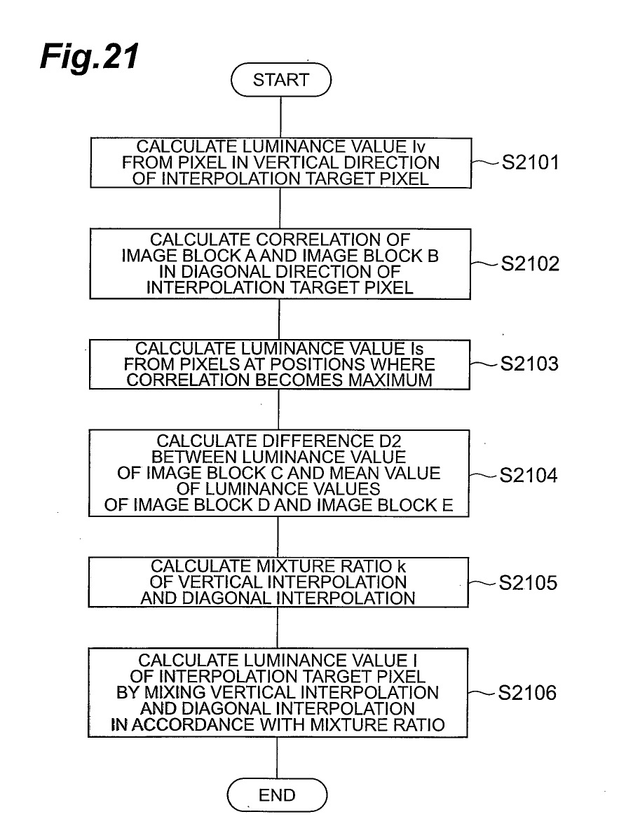

The above described interpolation processing of the luminance value in the image expansion apparatus 1 may be realized by using an exclusive circuit (LSI: Large Scale Integration) for interpolation processing, or may be realized by an MPU (Micro Processing Unit) executing an interpolation processing program. FIG. 21 shows a flowchart of the interpolation processing program.

In S2101, the image expansion apparatus 1 calculates the luminance value Iv by vertical interpolation from the luminance value of the pixel at the upper side of the interpolation target pixel 110 and the luminance value of the pixel at the lower side.

In S2102, the image expansion apparatus 1 calculates the correlation of the image block A and the image block B while shifting the image block A and the image block B existing in the diagonal direction of the interpolation target pixel 110 in the horizontal direction. At the same time, the image expansion apparatus 1 calculates the index value D1 of the correlation of the image block A and the image block B.

In S2103, the image expansion apparatus 1 specifies the image block A and the image block B having the largest correlation, and calculates the luminance value Is by diagonal interpolation from the luminance value of the pixel in the center of the image block A and the luminance value of the pixel in the center of the image block B.

In S2104, the image expansion apparatus 1 calculates the index value D2 expressing the edge shape in the periphery of the interpolation target pixel 110 based on the luminance value of the image block C including the interpolation target pixel 110 and the luminance values of the image block D and the image block E on the left and right of it. At the same time, the image expansion apparatus 1 calculates the index value D3 expressing the luminance value change in the vertical direction in the interpolation target pixel 110.

In S2105, the image expansion apparatus 1 calculates the mixture ratio k of the vertical interpolation and the diagonal interpolation based on the numerical values D1, D2 and D3 which are obtained from the above described computations.

In S2106, the image expansion apparatus 1 mixes the luminance value by the vertical interpolation and the luminance value by the diagonal interpolation in correspondence with the mixture ratio k, and calculates the luminance value I of the interpolation target pixel 110.

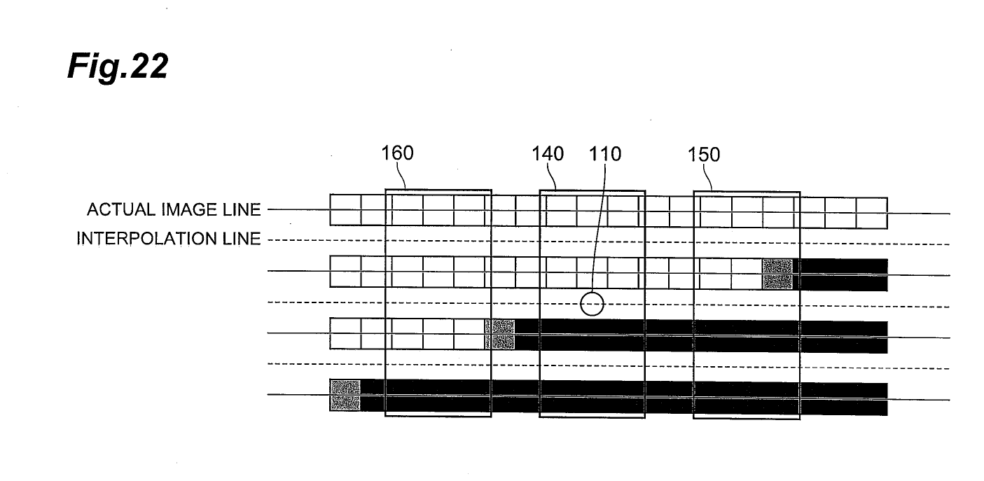

The present invention is not limited to the above described embodiment. For example, search of the correlation in the diagonal direction does not always have to be performed with the image block of three pixels by three pixels, but may be performed with image blocks in various sizes such as one pixel by one pixel, three pixels by one pixel, five pixels by three pixels and the like. Likewise, search of the edge shape does not always have to be performed with the image block of three pixels by two pixels, but may be performed with three pixels by four pixels as shown in FIG. 22, and may be performed with the other image blocks in various sizes such as one pixel by one pixel, and three pixels by five pixels.

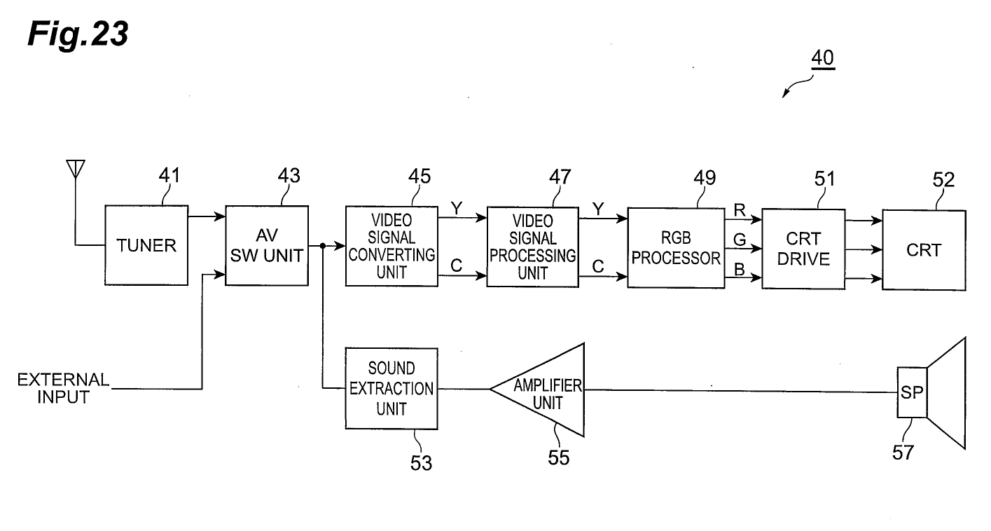

Subsequently, with reference to FIG. 23, one example of a television apparatus 40 (video display apparatus) including the above described image expansion apparatus 1 will be described. FIG. 23 is a block diagram showing one example of the television apparatus including the image expansion apparatus 1 according to this embodiment.

The television apparatus 40 includes a tuner 41 which is supplied with a broadcast signal from an antenna element, decodes the signal and outputs a video/audio signal, an AV switch (SW) part 43 which is supplied with the video/audio signal and performs switching with an external input, and a video signal conversion part 45 which applies predetermined video signal processing to a video signal when it is supplied thereto and converts it into a Y signal and a color difference signal and outputs them. The television apparatus further has an audio extracting part 53 which separates an audio signal from the video/audio signal, and an amplifying part 55 which properly amplifies the audio signal from the audio extracting part 53 to supply it to a speaker 57.

Here, in a video signal processing part 47 which is supplied with the video signal from the video signal conversion part 45, the above described image expansion apparatus 1 is applied. Non-interlaced video signal is separated by an RGB processor 49 into RGB signals, which are properly power-amplified by an CRT drive 51 and displayed as video by a CRT 52.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image expansion apparatus, comprising:
a vertical interpolating part obtaining a pixel value of an interpolation target pixel based on pixel values of an upper pixel and a lower pixel of the interpolation target pixel;
a diagonal interpolating part obtaining a pixel value of the interpolation target pixel based on pixel values of an pixel at a diagonally upper side and a pixel at a diagonally lower side of the interpolation target pixel, which are two pixels in opposite directions with the interpolation target pixel as a center;
a difference computing part obtaining a difference between a pixel value of an image block including the interpolation target pixel and a mean value of pixel values of two image blocks at both left and right sides of the image block, as an index value expressing an edge shape in a periphery of the interpolation target pixel; and
a mixing part mixing the pixel value of the interpolation target pixel obtained by said vertical interpolating part and the pixel value of the interpolation target pixel obtained by said diagonal interpolating part in accordance with a mixture ratio corresponding to the index value of the edge shape obtained by said difference computing part.

2. The image expansion apparatus according to claim 1,
wherein said difference computing part
obtains a total sum of pixel values of all pixels included in the image block as the pixel value of the image block including the interpolation target pixel,
obtains a half of a total sum of pixel values of all pixels included in the two image blocks as the mean value of the image values of the two image blocks at both the left and right sides, and
obtains a difference between the total sum of the pixel values of all the pixels included in the image block including the interpolation target pixel, and the half of the total sum of the pixel values of all the pixels included in the two image blocks.

3. The image expansion apparatus according to claim 1,
wherein as the index value of the edge shape obtained by said difference computing part is smaller, a ratio of the pixel value obtained by said vertical interpolating part in the mixture ratio is made smaller, and a ratio of the pixel value obtained by said diagonal interpolating part is made larger, and
as the index value of the edge shape obtained by said difference computing part is larger, the ratio of the pixel value obtained by said vertical interpolating part in the mixture ratio is made larger, and the ratio of the pixel value obtained by said diagonal interpolating part is made smaller.

4. The image expansion apparatus according to claim 1, further comprising a correlation computing part obtaining a difference of the pixel values of the two image blocks as an index value expressing correlation of the two image blocks including respective pixels used for interpolating the interpolation target pixel in said diagonal interpolating part,
wherein as the index value of the correlation obtained by said correlation computing part is smaller, a radio of the pixel value obtained by said vertical interpolating part in the mixture ratio is made smaller, and a ratio of the pixel value obtained by said diagonal interpolating part is made larger, and
as the index value of the correlation obtained by said correlation computing part is larger, a ratio of the pixel value obtained by said vertical interpolating part in the mixture ratio is made larger, and a ratio of the pixel value obtained by said diagonal interpolating part is made smaller.

5. The image expansion apparatus according to claim 1,
wherein said difference computing part further obtains a difference of the pixel values of the upper pixel and the lower pixel of the interpolation target pixel, as an index value expressing a pixel value change in a vertical direction in the interpolation target pixel,
as the index value of the pixel value change obtained by said difference computing part is larger, the ratio of the pixel value obtained by said vertical interpolating part in the mixture ratio is made smaller, and the ratio of the pixel value obtained by said diagonal interpolating part is made larger, and
as the index value of the pixel value change obtained by said difference computing part is smaller, the ratio of the pixel value obtained by said vertical interpolating part in the mixture ratio is made larger, and the ratio of the pixel value obtained by said diagonal interpolating part is made smaller.

6. The image expansion apparatus according to claim 1, further comprising a mixture ratio calculating part calculating a mixture ratio of the pixel value by the vertical interpolation and the pixel value by the diagonal interpolation based on the index value of the edge shape obtained by said difference computing part.

7. The image expansion apparatus according to claim 1,
wherein said mixture ratio calculating part obtains a parameter k in accordance with
$$k = \frac{( D 1 + 4 * D 2 ) * 2}{D 3}$$
where
D1: the index value of correlation
D2: the index value of edge shape
D3: the index value of pixel value change, and
said mixing part obtains an pixel value I of the interpolation target pixel in accordance with
I=k*Iv+(16−k)*Is
where
Iv: the pixel value by vertical interpolation
Is: the pixel value by diagonal interpolation.

8. A video display apparatus, comprising:
a vertical interpolating part obtaining a pixel value of an interpolation target pixel based on pixel values of an upper pixel and a lower pixel of the interpolation target pixel;
a diagonal interpolating part obtaining a pixel value of the interpolation target pixel based on pixel values of a pixel at a diagonally upper side and a pixel at a diagonally lower side of the interpolation target pixel, which are two pixels in opposite directions with the interpolation target pixel as a center;
a difference computing part obtaining a difference between a pixel value of an image block including the interpolation target pixel and a mean value of pixel values of two image blocks at both left and right sides of the image block as an index value expressing an edge shape in a periphery of the interpolation target pixel;
a mixing part mixing the pixel value of the interpolation target pixel obtained by said vertical interpolating part and the pixel value of the interpolation target pixel obtained by said diagonal interpolating part; and
a display displaying an image mixed by said mixing part.

9. An image expansion method, comprising:
obtaining a difference between a pixel value of an image block including an interpolation target pixel and a mean value of pixel values of two image blocks at both left and right sides of the image block as an index value expressing an edge shape in a periphery of the interpolation target pixel; and
mixing a pixel value of the interpolation target pixel obtained by vertical interpolation and a pixel value of the interpolation target pixel obtained by diagonal interpolation in accordance with a mixture ratio corresponding to the index value of the edge shape.
